(19) United States
(12) Patent Application Publication
(10) Pub. No.: US 2016/0090778 A1
(43) Pub. Date: Mar. 31, 2016

(54) ENDLESS LOOP CORD SAFETY DEVICE

(71) Applicant: Newell Window Furnishings, Inc., High Point, NC (US)

(72) Inventors: Joshua Lewis DeWard, Roswell, GA (US); Michelle Schroeder, Milton, GA (US)

(21) Appl. No.: 14/502,046

(22) Filed: Sep. 30, 2014

(51) Int. Cl. E06B 9/322

(52) U.S. Cl. CPC E06B 9/322

(57) ABSTRACT

The safety device is used with an endless loop cord that is operatively connected to the operating system of a window covering. When installed the end loop of the cord is reeved around a pulley, and the cord is wound onto a cord winder. The safety device is disposed at or close to the head rail of the window covering and a minimum length of cord is exposed between the head rail and the safety device. The safety device is extended away from the head rail such that the cord unwinds from the cord winder until the cord is completely unwound from the cord winder. The end loop of the cord remains reeved around the pulley. The safety device is mounted to a support surface.

### BACKGROUND

Window coverings such as shades and blinds are known that use endless loop or continuous loop cords to raise and lower and/or otherwise manipulate the shade panel. An endless loop cord typically comprises a first vertical side and a second vertical side that are connected at an end loop. The loose, exposed endless loop cord may present an entanglement hazard. Endless loop cords are commonly used in roller shades, blinds, cellular shades, roman shades, vertical blinds and drapery rods. The endless loop cord is typically connected to an operating system for moving the window covering upon manipulation of the cord. For example, one side of the cord may be pulled to move the operating system in a first direction and the opposite side of the cord may be pulled to move the operating system in the opposite direction. The movement of the operating system moves the panel of the window covering between, for example, raised and lowered positions.

### SUMMARY OF THE INVENTION

In some embodiments the safety device may be used with a window covering of the type comprising an endless loop cord having an end loop and a first side and a second side. The safety device comprises a rotatable pulley receiving the end loop of a cord. A cord winder is disposed adjacent the pulley where the cord winder winds both sides of the cord when rotated in a first direction. A motor rotates the cord winder in the first direction to a first position.

The cord winder may comprise a flange for engaging the first side and the second side when the cord winder rotates in the first direction. The pulley may rotate freely relative to the cord winder. The pulley may be mounted on a spindle such that the pulley rotates freely relative to the spindle. The cord winder may be mounted on the spindle over the pulley. The cord winder may comprise a second flange that is opposed to the first flange. The motor may comprise a spring. The spring may be deformed to store energy when the cord winder is rotated in a second direction. The spring may be positioned inside of a hub of the cord winder. In the first position the end loop of the endless cord may be reeved around the pulley and a length of the first side and a length of the second side may be wound around the cord winder. In the first position the safety device may be retracted adjacent to a head rail of a window covering. The safety device may assume a second position where the cord is completely unwound from the cord winder and the end loop is reeved around the pulley. A restraining device may be provided for holding the cord winder against rotation in the first direction. The cord winder and pulley may be located in a housing and the first side and the second side may extend from the housing. The restraining device may engage the housing and the cord winder to hold the cord winder in position relative to the housing. The restraining device may comprise a mounting screw for attaching the safety device to a support structure.

In one embodiment a method of assembling a safety device for a window covering comprising an endless loop cord having an end loop and a first side and a second side, comprises: reeving the end loop around a pulley; rotating a cord winder in a first direction such that as the cord winder rotates in the first direction the first side and the second side of the endless loop cord are substantially wound on the cord winder and the end loop is wrapped around the pulley.

The first side and the second side may be attached to an operating system of a window covering. The step of rotating the cord winder may comprise rotating the cord winder with a spring motor. Prior to the step of rotating the cord winder energy may be stored in the spring motor.

In some embodiments, a safety device for a window covering comprising an endless loop cord having an end loop and a first side and a second side, comprises a pulley assembly including a rotatable pulley receiving the end loop of a cord. A cord winder is mounted to the pulley assembly for independent rotation relative to the pulley, the cord winder winding both sides of the cord when rotated in a first direction. A releasable connection is configured to allow the cord winder to be removed from the pulley assembly.

### BRIEF DESCRIPTION OF THE DRAWINGS

FIG. 1 is a perspective view of an embodiment of a window covering showing an embodiment of the safety device of the invention in phantom.

FIG. 2 is a perspective view of an embodiment of a window covering showing an embodiment of the safety device of the invention in an inoperative position.

FIGS. 3 and 4 are perspective views of embodiments of a window covering showing an embodiment of the safety device of the invention in an operative position.

FIG. 5 is an exploded perspective view of an embodiment of the safety device of the invention.

FIG. 6 is an exploded side view of the safety device of FIG. 5.

FIG. 7 is a section view of the safety device of FIG. 5.

FIG. 8 is an exploded perspective view of another embodiment of the safety device of the invention.

FIG. 9 is a section view of the safety device of FIG. 8.

### DETAILED DESCRIPTION OF PREFERRED EMBODIMENTS OF THE INVENTION

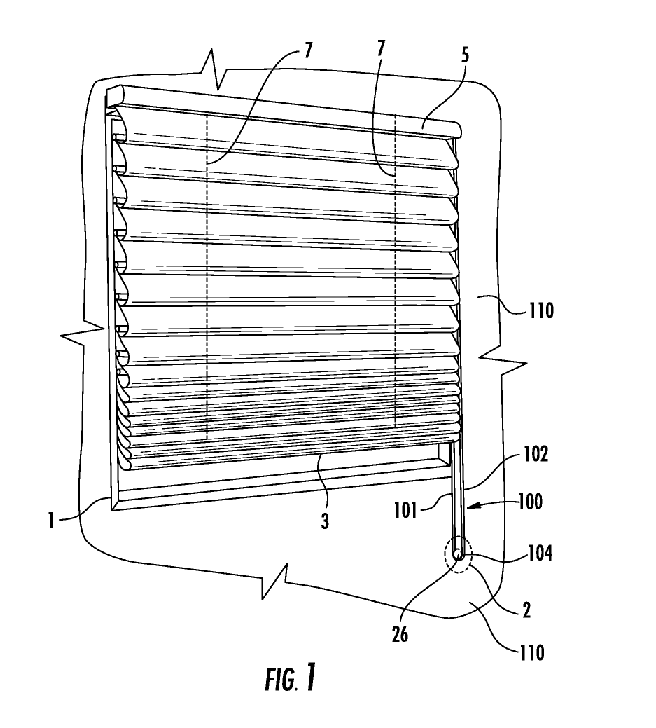

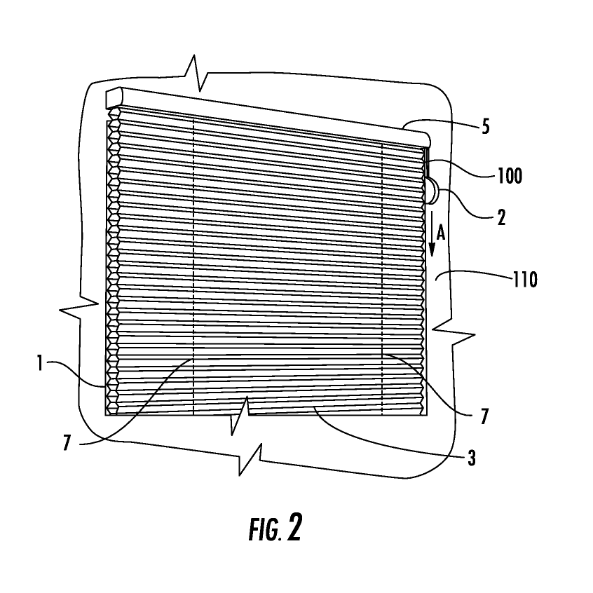

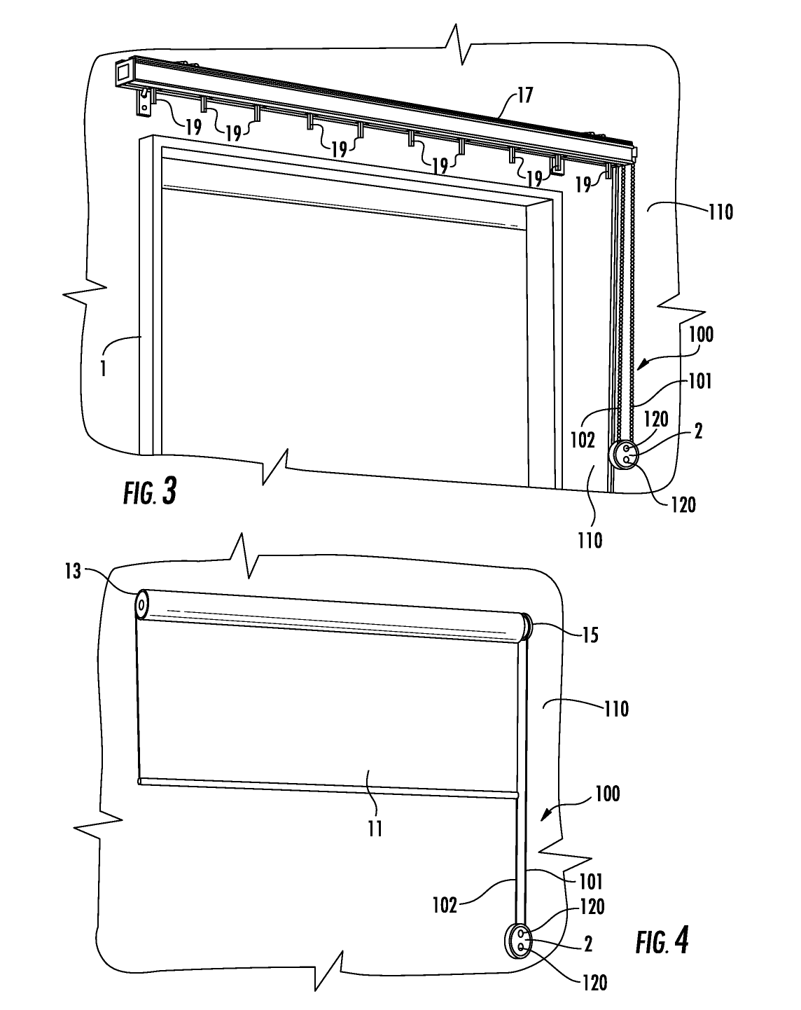

The safety device of the invention may be used on any window covering having an endless or continuous loop operating cord (referred to herein as “endless loop cord” or “cord”). Endless loop cords are used in a variety of different styles of window coverings to control the operation of a movable panel. FIGS. 1 and 2 show an example of one such window covering with which an endless loop cord 100 and safety device 2 may be used. The window coverings shown in FIGS. 1 and 2 are bottom up shades comprising a flexible panel 3 that is supported for movement relative to a head rail 5 or other structure by an operating system. The operating system may comprise at least one lift cord 7 connected to the panel 3. The lift cords 7 may be connected to a bottom of panel 3 in a traditional shade and/or to the top of panel 3 in a top down shade. The lift cords 7 are typically wound on a spool in the head rail 5 such that as the spool is rotated in a first direction the lift cords are unwound from the spool and the panel 3 is lowered and when the spool is rotated in the opposite direction the lift cords are wound on the spool and the panel 3 is raised. An endless loop cord 100 is wound around an operating member such as a pulley where the pulley forms part of the operating system for raising and lowering the panel. One side 101 of the endless cord 100 may be pulled by a user to rotate the spools in the first direction and the opposite side 102 of the endless cord 100 may be pulled to rotate the spools in the opposite direction. The sides 101, 102 of the cord meet at an end loop 104. The panel 3 in such a system may be a Roman shade (FIG. 1), cellular shade (FIG. 2), or other suitable shade style. Another type of window covering that uses an endless cord comprises a roller shade an embodiment of which is shown in FIG. 4. In a roller shade a flexible panel 11 is wound on a roller 13 such that as the roller is rotated in a first direction the panel is unwound from the roller and lowered and when the roller is rotated in the opposite direction the panel is wound on the roller and raised. An endless cord 100 is wound around an operating member of an operating system such as a pulley 15 where the pulley 15 is operatively connected to the roller 13. One side 101 of the endless cord 100 may be pulled by a user to rotate the roller in the first direction and the opposite side 102 of the endless cord 100 may be pulled to rotate the roller in the opposite direction. The panel 11 may be constructed of a variety of materials and styles. As shown in FIG. 3, another type of window covering that uses an endless cord 100 comprises a vertical blind where a plurality of vertical blind vanes (not shown) that together define a shade panel are supported by a head rail 17 or other structure by adjustable carriers 19 that may be moved linearly along the length of the head rail 17 and/or rotated about a vertical axis by an operating system in head rail 17. The endless cord 100 is operatively connected to the operating system such that when the endless cord 100 is pulled by a user the carriers 19 may be moved linearly and/or rotated about a vertical axis depending upon the arrangement of the operating system. One side 101 of the endless cord is pulled to move the carriers 19 in a first direction and the opposite side of the endless cord 101 is pulled to move the carriers 19 in a second direction. Endless loop operating cords may also be used to control the opening and closing of draperies by controlling movement of the drapery rod carriers. Operating systems used with endless loop cords may take many forms and may be used to control various functions of the window covering.

The endless loop cord 100 in these and other embodiments may be made of a variety of materials and configurations including but not limited to a cord, beaded chain or the like. Endless loop cords may be used with a variety of different types of operating systems to control various functions of a window covering. The safety device 2 of the invention has applicability in any window covering operating system that uses an endless loop operating cord to control one or more functions of the window covering. In FIGS. 3 and 4 the safety device 2 is shown in the operative position attached to cord 100 and mounted to a surface adjacent the window covering. In the embodiment of FIG. 1 the endless loop cord 100 is shown with the safety device 2 in phantom lines to show the end loop 104 of cord 100. In FIG. 2 the safety device 2 is shown in the inoperative position attached to cord 100 but not mounted to a surface adjacent the window covering.

The safety device 2 may be mounted to the endless loop operating cord 100 of a window covering. Typically, the safety device 2 is mounted to the endless loop cord 100 by the manufacturer as part of the manufacturing process such that the safety device is mounted on the endless loop cord (as shown in FIG. 2) when the customer receives the window covering. The safety device prevents operation of the window covering until the safety device is properly installed with the window covering (FIGS. 3 and 4). If the window covering and safety device are not properly installed the endless loop cord cannot operate the window covering through its full range of intended travel. In some embodiments the safety device 2 may be installed on existing window coverings.

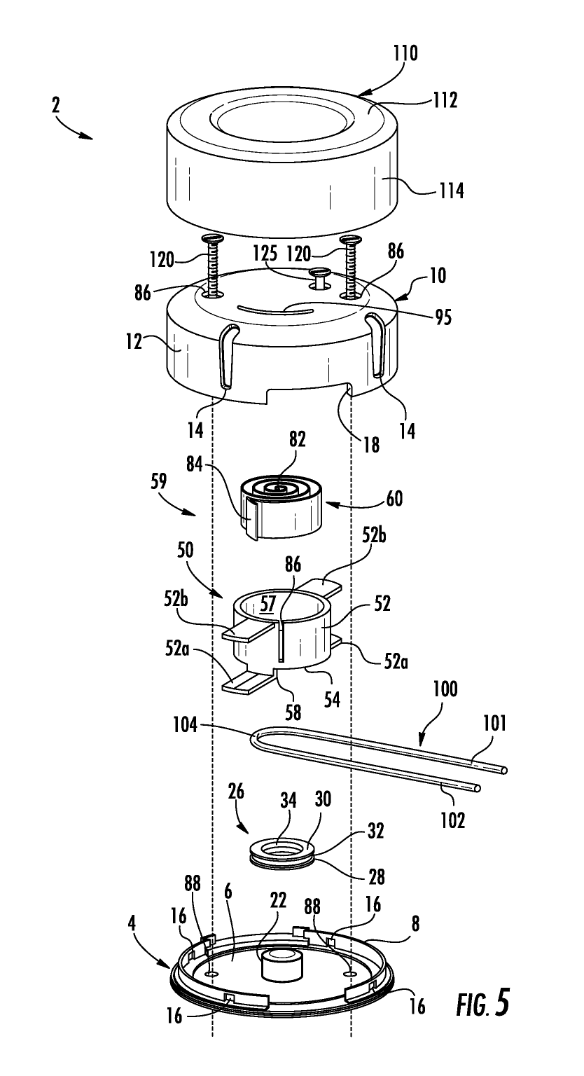

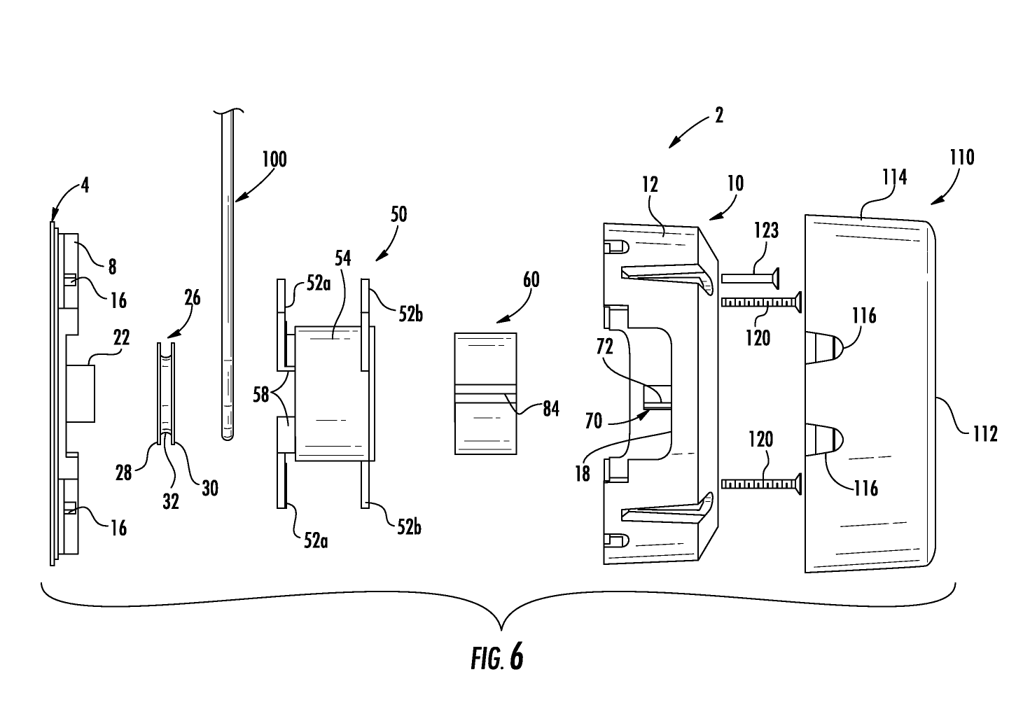

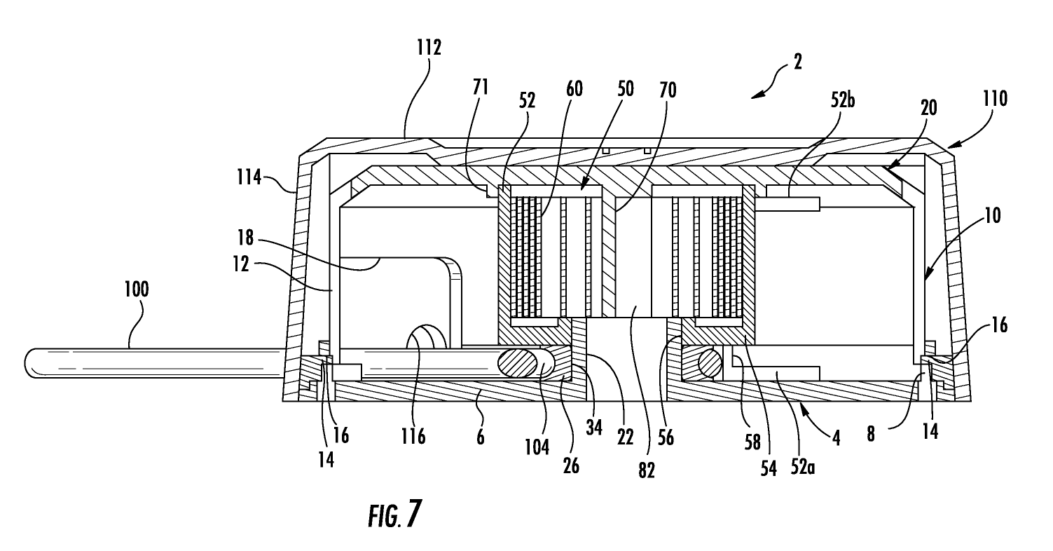

One embodiment of the safety device will be described with respect to the embodiment shown in FIGS. 5-7. The safety device 2 comprises a base 4 comprising a planar back member 6 from which a perimeter wall 8 extends. The perimeter wall 8 is set back from the perimeter edge of the back member 6 such that a mounting cover 10 may be secured to the base 4 with the perimeter wall 12 of the mounting cover 10 disposed outside of the wall 8. A mating snap-fit feature may be used to secure the mounting cover 10 to the base 4. For example projecting fingers or tangs 14 on the mounting cover 10 may engage recesses or apertures 16 formed on the base 4. The mounting cover 10, base 4 or both may deform slightly such that the cover 10 may be pressed onto the base 4 such that the fingers 14 and apertures 16 engage in a snap-fit connection. The elements may be reversed such that the fingers 14 are formed on the base 4 and the mating apertures or recesses 16 are formed on the mounting cover 10. Moreover, a connection mechanism other than a snap-fit connection may be used to connect the cover 10 to the base 4 such as adhesive, welding, separate fasteners, screw threads or the like. The base 4 and cover 10 are joined to form the housing 20 that contains the components of the safety device 2. The housing 20 may have a variety of structures and configurations other than that specifically shown. Housing 20 comprises a cord aperture 18 through which the endless loop cord 100 extends.

The base 4 further supports a spindle 22 that extends into the interior space of the housing 20. The spindle 22 may be formed integrally with the base 4 such as by molding the base 4 and spindle 22 out of plastic. Alternatively, the spindle 22 may comprise a separate component from the base 4 that is permanently fixed to the base.

A pulley 26 is mounted on the spindle 22 such that the pulley 26 rotates freely relative to the spindle 22. The pulley 26 may comprise an internal round aperture 34 that fits over the outer cylindrical surface of the spindle 22. The pulley 26 may be mounted for rotation on the spindle 22 using other mechanisms. The pulley 26 has two flanges 28 and 30 that define a circumferential groove 32 that is dimensioned to receive the end loop 104 of the endless loop operating cord 100. If the cord 100 comprises a beaded chain the groove 32 may comprise mating recessed areas to matingly engage the beads on the chain.

A cord winder 50 is mounted on the spindle 22 such that the cord winder 50 rotates freely relative to the spindle 22 and rotates freely and independently relative to the pulley 26. The cord winder 50 comprises a tubular hub 52 that is open at one end and is closed at its other side by a wall 54. The wall 54 of the hub 52 faces the base 4 and is formed with a central aperture 56 that fits over the spindle 22 such that the winder 50 may rotate on the spindle 22. A pair of opposed flanges extend from the hub 52 that receive cord 100 therebetween as the cord 100 is wound on the hub 52. Each pair of opposed flanges comprises a first inner flange 52a that extends from one side of the hub 52 and a second outer flange 52b that extends from the opposite side of the hub 52. The inner flange 52a is positioned by an arm 58 such that it extends beyond the wall 54 of the hub 52 a distance slightly greater than the width of the pulley 26. As a result the pulley 26 may be mounted on the spindle 22 and the winder 50 may be mounted on the spindle 22 over the pulley 26 such that the pulley 26 is positioned on the spindle 22 between the base 4 and the winder 50. The inner flanges 52a are configured such that the outer surfaces of the flanges 52a rest on and slide over, or are closely adjacent to, the interior surface of back member 6 of the base 4. The winder 50 and the pulley 26 rotate independently of one another. The spacing between the arms 58 is wider than the diameter of the pulley 26 a distance sufficient that the cord 100 may be reeved around the pulley 26 and threaded between pulley and the arms 58 without interference from the winder 50.

The mounting cover includes an annular flange 71 that receives the end of the hub 52 to stabilize the cord winder 50 as it rotates. The mounting cover 10 supports a post 70 that extends into the interior space of the housing 20. The post 70 may be formed integrally with the mounting cover 10 such as by molding the mounting cover 10 and the post 70 out of plastic. Alternatively, the post 70 may comprise a separate component from the mounting cover 10 that is permanently fixed to the mounting cover 10. The post 70 comprises a longitudinally extending slot 72. The elements may be reversed such that the spindle 22 is formed on the mounting cover 10 and the post 70 is formed on the base 4.

A motor 59 is used to rotate the cord winder 50 in a first direction and to allow the cord winder to rotate in a second opposite direction. In one embodiment the motor 59 comprises spring motor including a coil power spring 60 that is positioned in the cylindrical internal space 57 of the hub 52 of the winder 50. A first end 82 of spring 60 is fixed relative to the housing. In one embodiment, the first inner end 82 of the spring 60 is inserted into the slot 72 of the post 70 such that the first end 82 of the spring 60 is fixed in position relative to the housing 20. The opposite, outer end 84 of the coil spring 60 is fixed to the winder 50. In one embodiment a slot 86 is formed in the wall of the hub 52 that receives the second end 84 of the spring 60 such that the second end 84 of the spring 60 moves with the winder 50 as the winder rotates on spindle 22. The coil spring 60 is wound by turning the hub 52 relative to the housing 20 such that as the winder 50 is rotated relative to the housing in a first direction the spring 60 is deformed inside of hub 57 and stores energy. When the winder 50 is released, the spring 60 unwinds and the stored energy rotates the cord winder 50 in a second opposite direction.

To assemble the safety device 2 the pulley is mounted on spindle 22 and the cord winder 50 is mounted on spindle 22 over the pulley 26. The spring 60 is inserted into hub 54 and the inner end of the spring is inserted into slot 72 and fixed to post 70 and the outer end 84 is inserted into slot 86 and fixed to cord winder 50. The cord winder 50 is rotated in the first direction relative to the base 4 to a loaded position where the spring 60 is deformed and energy is stored in the spring. A pin, clamp or other restraining device may be used to temporarily hold the cord winder 50 in the loaded position during assembly of the safety device 2. For example, a pin may be inserted through an aperture in the housing 20 that interferes with rotation of the cord winder to prevent the cord winder from rotating in the second direction into contact with cord 100. A central portion of the endless loop cord 100 is reeved around the pulley 26 such that the looped end 104 of the cord is around the pulley 26 and the two sides 101, 102 of the cord extend out of the housing 20 through cord aperture 18. The cover 10 is attached to the base 4 to complete the assembly.

The restraining device is released from the cord winder 50 and the cord winder is allowed to rotate under power of the spring 60. The spring 60 rotates the cord winder 50 in the second direction such that as the cord winder 50 rotates both sides 101, 102 of the endless loop cord 100 are wound on the drum 54 of the cord winder 50 between the opposed pairs of flanges 52a, 52b. As the cord winder 50 rotates in the second direction, the inner flanges 52a, which are disposed against the base 4, sweep both sides 101, 102 of the cord 100 onto the drum 54 and between the opposing flanges 52a, 52b such that rotation of the cord winder 50 winds both sides of the cord onto the cord winder. In the wound position the end loop 104 of the cord 100 is wrapped around the pulley 26 with substantially the remaining length of cord wound around the drum 52 of the cord winder 50. The assembly steps of the safety device 2 may be performed in an order other than that described.

When the endless loop cord 100 is operatively connected to the operating system of a window covering that is located in a head rail or other similar structure, the safety device 2 is retracted adjacent to the head rail 5 as the endless loop cord 100 is wound on the cord winder 50 to the position of FIG. 2. In some embodiments the endless loop cord 100 may be connected to the operating system of the window covering before the safety device 2 is attached to the cord 100 such that the safety device 2 retracts toward the head rail or other support structure as the cord 100 is wound on the cord winder. In other embodiments the safety device 2 may be installed on the cord 100 before the cord is connected to the operating system. In such an operation the safety device 2 retracts the cord 100 into housing but leaves a sufficient amount of exposed cord that the two sides 101, 102 of the cord may be operatively connected to the operating system of the window covering.

In the installed retracted position the energy of the spring 60 has been spent or partially spent winding the cord 100 onto the cord winder 50, the safety device 2 is disposed at or close to the head rail, and a minimum length of cord 100 is exposed between the head rail and the safety device 2 as shown in FIG. 2. Because, at most, a short length of cord 100 is exposed between the head rail 5 and the safety device 2 and the cord is wrapped around cord winder 50, the cord 100 cannot be used to operate the window covering through its full intended travel. The window covering with the safety device 2 may be delivered to the customer in the inoperable condition such that the window covering must be properly installed before it may be used.

To install the window covering, the head rail or other support structure 5 is attached to, or adjacent, a window or other architectural feature 1 with which the window covering is to be used. The safety device 2 is in the retracted, inoperable position of FIG. 2. The user pulls on the safety device 2 to extend the safety device 2 away from the head rail in the direction of arrow A, typically in a downward direction, such that the cord 100 unwinds from the cord winder 50 to the position shown in FIGS. 1, 3 and 4. The safety device 2 is moved away from the head rail until the cord 100 is completely unwound from the drum 52 of the cord winder 50. In this position the cord 100 is completely unwound from the cord winder 50 but the end loop 104 of the cord 100 is wrapped around the pulley 26 approximately a half turn.

The safety device 2 is secured to the window frame, wall or other structure 110 adjacent the window or other architectural feature in the fully extended position. In one embodiment, screws or other fasteners 120 may be inserted through aligned apertures 86, 88 formed in the cover 10 and base 4, respectively, such that the screws or other fasteners may engage the wall or other structure behind the safety device 2 and be screwed into the wall or other structure from the front of the safety device. While one mechanism for attaching the safety device 2 to the wall is described, the safety device 2 may be secured to the wall or other structure 110 by any suitable attachment mechanism. For example the housing 20 may be provided with extending flanges that receive the screws or other fasteners. A separate mounting bracket may be mounted to the wall or other structure that receives and retains the safety device 2. Other mounting systems may also be used.

Once the safety device 2 is mounted to the wall or other support structure 110 with the cord 100 fully extended from the housing, the endless loop cord 100 may be used to control the window covering operating system. As previously described, either side 101, 102 of the endless loop cord 100 may be pulled to move the operating member of the operating system in one of two directions. As either side 101, 102 of the endless loop cord 100 is pulled, the cord 100 rides in pulley 26 and the pulley freely rotates on spindle 22 to facilitate movement of the cord. During operation of the window covering the cord winder 50 provides no functionality and the safety device 2 only provides the bottom pulley for supporting the end loop 104 in a fixed position and for facilitating movement of the cord 100.

While the cord winder 50 provides no function during operation of the window covering, after the safety device 2 is installed, the spring 60 is in the loaded condition due to rotation of the cord winder 50 as the cord is unwound from the cord winder. The spring 60 exerts a force on the cord winder 50 tending to rotate the cord winder in the second direction. The cord winder 50 rotates until it contacts the cord 100. Because the safety device 2 is fixed to the wall or other support structure the rotation of the cord winder 50 stops when the cord winder abuts the cord 100. The abutting engagement of one of the inner flanges 52a of the cord winder 50 against the cord 100 may make movement of the cord 100 through the safety device 2 more difficult and may cause excess wear on the cord. To eliminate these issues, after installation of the safety device 2 on the wall or other support structure, the cord winder 50 may be rotated against the spring force away from the cord 100 to a non-interfering position to prevent rubbing of the cord 100 against the flanges 52a of the cord winder 50 during operation of the cord. In one embodiment, an aperture 95 may be formed in the housing 20 such as in the front of the cover 10. The aperture 95 allows access to the interior of the housing 20 where one or both of the flanges 52b of the cord winder 50 are accessible. In one embodiment the aperture 95 comprises a curved slot that follows the rotational motion of the cord winder. For example, the slot may be formed as an arc of a circle that is centered on the axis of rotation of the cord winder 50. The user inserts a tool, such as a screwdriver, through the slot 95 to engage the cord winder 50 and rotate the cord winder in the second direction such that the inner flanges 52a of the cord winder are rotated away from the cord 100 and do not interfere with the movement of the cord. The cord winder 50 is then fixed in the non-interfering position relative to the housing 20 by a restraining member. In one embodiment, one or both of the mounting screws 120 for mounting the safety device 2 to the wall or other structure may be used as the restraining member. The cord winder 50 is moved to a position where it is not in contact with cord 100. One of screws 120 is inserted into apertures 86 and 88 such that the screw is positioned to stop rotation of the cord winder 50 and prevent the cord winder from rotating back into contact with the cord. In some embodiments a separate fastener, pin or other member 123 (other than the mounting screws 120) may be used as the restraining member for holding the cord winder 50 out of contact with cord 100. The restraining member 123 may comprise a screw, pin or the like that is inserted through an aperture in the housing 20 to prevent the cord winder 50 from rotating relative to the housing. Other mechanisms may also be used as the retaining member such as a movable stop 125 mounted on the housing, a deformable housing portion, a friction brake or the like. Different forms of the restraining mechanism may be used provided that the restraining mechanism is capable of holding the cord winder 50 in a position where the flanges 52a do not interfere with or engage the cord 100 during operation of the window covering. In some embodiments the restraining member may be removed or disengaged from the cord winder 50 if the safety device is detached from the wall or other supporting surface to thereby allow the cord winder 50 to rotate under the force of the spring 60 and retract the cord into the safety device 2 to the inoperable position. The window covering may then be reinstalled and reused.

A decorative cover 110 may be provided that is configured to fit over the safety device 2 after installation of the safety device is completed. The decorative cover 110 may comprise a decorative face plate 112 connected to a side wall 114. The decorative cover may include trademark information, decorative designs or the like. The side wall 114 may comprise an aperture or apertures 116 that allow the sides 101, 102 of the cord 100 to extend outside of the decorative cover 110. The decorative cover 110 may be attached to the safety device by a snap-fit connector, separate fasteners, a threaded connector or the like.

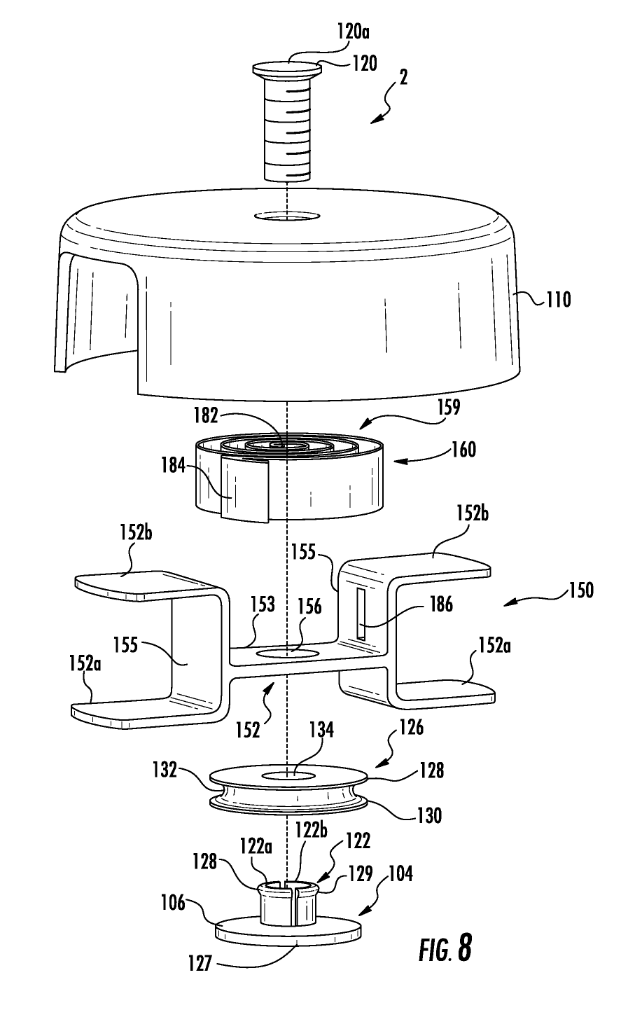

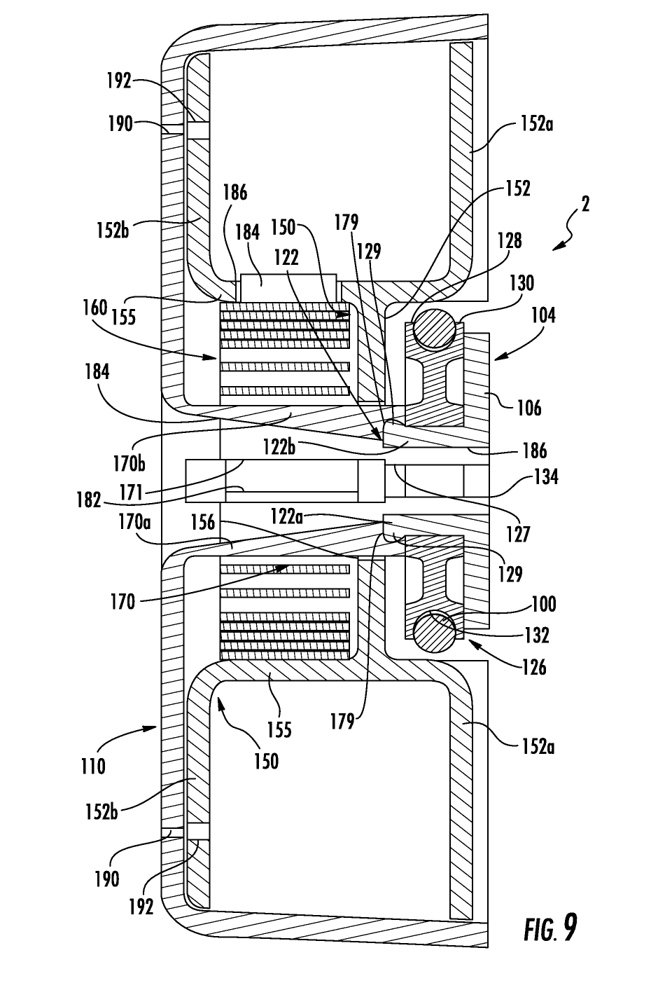

In another embodiment, the safety device 2 is configured such that it can be removed from the wall after proper installation of the window covering. Referring to FIGS. 8 and 9 an embodiment of the safety device is shown. The safety device 2 comprises a pulley assembly comprised of a base 104 and a pulley 126. The base 105 comprises a planar back member 106 that supports a spindle 122 that extends from the back member 106 into the interior space of the cover 110. The spindle 122 may be formed integrally with the back member 106 such as by molding the back member 106 and spindle 122 out of plastic. Alternatively, the spindle 122 may comprise a separate component from the back member 106 that is permanently fixed to the back member 106.

A pulley 126 is mounted on the spindle 122 such that the pulley 126 rotates freely relative to the spindle 122. The spindle 122 has a two piece construction formed by a first member 122a and a second member 122b separated by slots 127 such that the members may flex slightly relative to one another. A flange 129 is formed at the distal ends of members 122a, 122b that projects outwardly from the spindle 122. The pulley 126 may comprise an internal round aperture 134 that fits over the outer cylindrical surface of the spindle 22. The pulley 126 may be forced over the flanges 129 to deform the members 122a and 122b and force the members toward one another such that the flanges 129 may pass through the aperture 134. The members 122a and 122b return to their undeformed state once the pulley 126 is seated on the spindle 122 such that the flanges 129 maintain the pulley 126 on the cylindrical surface defined by members 122a and 122b. The pulley 126 may be mounted for rotation on the spindle 122 using other mechanisms. The pulley 126 has two flanges 128 and 130 that define a circumferential groove 132 that is dimensioned to receive the end loop 104 of the endless loop operating cord 100. If the cord 100 comprises a beaded chain the groove 132 may comprise mating recessed areas to matingly engage the beads on the chain.

The cover 110 is also mounted to the spindle 122. The cover 110 comprises a post 170 that extends from the interior of the cover and is positioned opposite to the spindle 122. The post 170 cord has a two piece construction formed by a first member 170a and a second member 170b separated by slots 171 such that the members may flex slightly relative to one another. A recess 179 is formed at the distal ends of members 170a, 170b that receive the flange 129 of spindle 122. The members 170a, 170b may be forced over the flanges 129 to deform the members 170a and 170b and force the members away from one another such that the flanges 129 may engage the recesses 179. The members 170a, 170b deflect to their undeformed state once the spindle 122 is inserted into the post 170 such that the engagement of flanges 179 with recesses 179 maintain the cover 110 on the spindle 122. The post 170 may be formed integrally with the mounting cover 110 such as by molding the mounting cover 110 and the post 170 out of plastic. Alternatively, the post 170 may comprise a separate component from the mounting cover 110 that is permanently fixed to the mounting cover 110. The engagement of the post 170 and the spindle 122 may take other forms. For example, the male engagement member or flange 129 may be formed on the post 170 and the female engagement member or recess 179 may be formed on the spindle 122. The post 170 comprises a longitudinal passage or through hole 184 and the spindle 122 and back member 106 comprise a longitudinal passage or through hole 186 that is aligned with passage 184 to define a passage through the safety device.

A cord winder 150 is mounted on the post 170 such that the cord winder 150 rotates relative to the post 170 and rotates independently relative to the pulley 126. The cord winder 150 comprises a hub 152 formed by a central support 153 and a pair of transverse supports 155 attached to the ends of the central support 153. The central support 153 includes a centrally located bore 156 that fits over the post 170 such that the winder 150 may freely rotate on the post 170. A pair of opposed flanges 152a, 152b extend from the hub 152 that receive cord 100 therebetween as the cord 100 is wound on the hub 52. Each pair of opposed flanges 152a, 152b comprises a first inner flange 152a that extends from one side of the hub 152 and a second outer flange 152b that extends from the opposite side of the hub 152. The inner flanges 152a are configured such that a cord 100 reeved around pulley 126 will be wound between the opposed flanges 152a, 152b. The spacing between the transverse supports 152b is wider than the diameter of the pulley 126 a distance sufficient that the cord 100 may be reeved around the pulley 126 and threaded between pulley 126 and the transverse supports 155 without interference from the winder 150.

As previously described, a motor 159 may be used to rotate the cord winder 150 in a first direction and to allow the cord winder to rotate in a second opposite direction. In one embodiment the motor 159 comprises spring motor including a coil power spring 160 that is positioned in the internal space between the cover 110 and the winder 150. A first end 182 of spring 160 is fixed relative to the housing. In one embodiment, the first inner end 182 of the spring 160 is inserted into a slot 171 of the post 170 such that the first end 182 of the spring 160 is fixed in position relative to the cover 110. The opposite, outer end 184 of the coil spring 160 is fixed to the winder 150. In one embodiment a slot 186 is formed in the support 155 of the hub 152 that receives the second end 184 of the spring 160 such that the second end 184 of the spring 160 moves with the winder 150 as the winder rotates on post 170. The coil spring 160 is wound by turning the hub 152 relative to the cover 110 such that as the winder 150 is rotated relative to the housing in a first direction the spring 160 is deformed and stores energy. When the winder 150 is released, the spring 160 unwinds and the stored energy rotates the cord winder 150 in a second opposite direction.

To assemble the safety device 2 the pulley 126 is mounted on spindle 122 and the cord winder 50 is mounted on post 170 with spring 160 between cord winder 150 and cover 110. The inner end 182 of the spring 160 is inserted into a slot 182 formed in post 170 and is thereby fixed to post 170 and the outer end 184 is inserted into slot 186 and fixed to cord winder 150. The post 170 is attached to the pulley 126 by snapping the post members 170a, 170b to the spindle members 122a and 122b. The cord winder 150 is rotated in the first direction relative to the cover 110 to a loaded position where the spring 160 is deformed and energy is stored in the spring. A pin, clamp or other restraining device may be used to temporarily hold the cord winder 150 in the loaded position during assembly of the safety device 2. For example, a pin may be inserted through an aperture 190 in the cover 110 and an aperture 192 in the cord winder 150 that prevents the cord winder from rotating in the second direction into contact with cord 100. The cord 110 is reeved around the pulley 126. The restraining member is released such that the spring 160 rotates the cord winder 150 in a first direction relative to the base 104 such that as the cord winder 150 rotates both sides 101, 102 of the endless loop cord 100 are wound on the cord winder 150 between the opposed pairs of flanges 152a, 152b. As the cord winder 150 rotates in the first direction, the inner flanges 152a sweep both sides 101, 102 of the cord 100 onto the cord winder between the opposing flanges 152a, 152b such that rotation of the cord winder 150 winds both sides of the cord onto the cord winder. In the wound position the end loop 104 of the cord 100 is wrapped around the pulley 126 with substantially the remaining length of cord wound around the cord winder 150. The assembly steps of the safety device 2 may be performed in an order other than that described.

When the endless loop cord 100 is operatively connected to the operating system of a window covering that is located in a head rail or other similar structure, the safety device 2 is retracted adjacent to the head rail 5 as the endless loop cord 100 is wound on the cord winder 50 to the position of FIG. 2. In some embodiments the endless loop cord 100 may be connected to the operating system of the window covering before the safety device 2 is attached to the cord 100 such that the safety device 2 retracts toward the head rail or other support structure as the cord 100 is wound on the cord winder. In other embodiments the safety device 2 may be installed on the cord 100 before the cord is connected to the operating system. In such an operation the safety device 2 retracts the cord 100 into housing but leaves a sufficient amount of exposed cord that the two sides 101, 102 of the cord may be operatively connected to the operating system of the window covering.

In the installed retracted position the energy of the spring 160 has been spent or partially spent winding the cord 100 onto the cord winder 150, the safety device 2 is disposed at or close to the head rail, and a minimum length of cord 100 is exposed between the head rail and the safety device 2 as shown in FIG. 2. Because, at most, a short length of cord 100 is exposed between the head rail 5 and the safety device 2 and the cord is wrapped around cord winder 150, the cord 100 cannot be used to operate the window covering through its full intended travel. The window covering with the safety device 2 may be delivered to the customer in the inoperable condition such that the window covering must be properly installed before it may be used.

To install the window covering, the head rail or other support structure 5 is attached to, or adjacent, a window or other architectural feature 1 with which the window covering is to be used. The safety device 2 is in the retracted, inoperable position of FIG. 2. The user pulls on the safety device 2 to extend the safety device 2 away from the head rail in the direction of arrow A, typically in a downward direction, such that the cord 100 unwinds from the cord winder 150 to the position shown in FIGS. 1, 3 and 4. The safety device 2 is moved away from the head rail until the cord 100 is completely unwound from the cord winder 150. In this position the cord 100 is completely unwound from the cord winder 150 but the end loop 104 of the cord 100 is wrapped around the pulley 126 approximately a half turn.

The safety device 2 is secured to the window frame, wall or other structure 110 adjacent the window or other architectural feature in the fully extended position. In one embodiment, a screw or other fastener 120 is inserted through aligned through holes 184 and 186 formed in the post 170 and the spindle 126, respectively, such that the screw or other fastener 120 engages the internal surfaces of members 170a and 170b. In one embodiment the head 120a of the screw or other fastener 120 has a diameter that is approximately equal to the diameter of spindle 126 including flanges 129. As the screw is threaded into the wall or other structure from the front of the safety device 2 the head 120a of the screw 120 pushes the members 170a, 170b away from one another such that the recesses 179 are released from the flanges 129 and the post 170 is released from the spindle 126. In one embodiment the internal diameter of the through hole 186 decreases from the outer end of the cover 110 toward the base 104. As a result the distance between the internal surfaces of members 170, 170b decreases such that as the screw or other fastener 120 enters the through hole 186 the head of the screw forces members 170a and 170b away from one another a sufficient distance to release spindle 126. The members 170a and 170b may fracture as they are pushed apart or they may simply deform without fracturing. The cover 110, post 170, spring 160 and cord winder 150 may be removed from the pulley assembly such that only the base 104 and pulley 130 remain attached to the wall or other support structure by screw or other fastener 120. Once the safety device 2 is mounted to the wall or other support structure 110 with the cord 100 fully extended from the housing, the endless loop cord 100 may be used to control the window covering operating system. As previously described, either side 101, 102 of the endless loop cord 100 may be pulled to move the operating member of the operating system in one of two directions. As either side 101, 102 of the endless loop cord 100 is pulled, the cord 100 rides in pulley 126 and the pulley freely rotates on spindle 122 to facilitate movement of the cord. While one releasable attachment mechanism between the cover and the spindle is disclosed other releasable mechanisms may be used.

Unlike in the prior embodiments, if the safety device is detached from the wall or other supporting surface the cord winder 150 may not be able to be reused to retract the cord into the safety device 2 to the inoperable position.

In some embodiments, the post 170 may be releasably attached to the spindle 126 or base 104 using a connection mechanism other than a frangible connector described above. For example, the post may deform but otherwise not be broken such that the post may be reinserted on the spindle as previously described. The cover may also be attached to the pulley assembly using screw threads, separate fasteners, other snap-fit connection or the like that allows the cover 110 and cord winder 150 to be remounted on the pulley assembly if the pulley assembly is removed from the wall such that the cord 100 may be rewound on the safety device and the safety device reused. In some embodiments the spring motor, cord winder and cover of the embodiments of FIGS. 1-7 may be made removable and reattachable to base 4 such that the powered cord winder may be removed after attachment of the pulley 26 to the wall. In such an embodiment the base and pulley of the embodiment of FIGS. 1-7 remains attached to the wall.

A decorative cover 110 may be provided that is configured to fit over the pulley 126 and base 104 after installation of the safety device is completed. The decorative cover 110 may comprise a decorative face plate connected to a side wall as previously described. The decorative cover may include trademark information, decorative designs or the like. The side wall 114 may comprise an aperture or apertures that allow the sides 101, 102 of the cord 100 to extend outside of the decorative cover 110. The decorative cover 110 may be attached to the safety device by a snap-fit connector, separate fasteners, a threaded connector or the like.

Various embodiments of the invention have been described and illustrated. However, the description and illustrations are by way of example only. Other embodiments and implementations are possible within the scope of the invention and will be apparent to those of ordinary skill in the art. Therefore, the invention is not limited to the specific details of the representative embodiments, and illustrated examples in this description. Accordingly, the invention is not to be restricted except as necessitated by the accompanying claims and their equivalents.

1. A safety device for a window covering comprising an endless loop cord having an end loop and a first side and a second side, comprising:
a rotatable pulley receiving the end loop of a cord;
a cord winder disposed adjacent the pulley, the cord winder winding both sides of the cord when rotated in a first direction;
a motor for rotating the cord winder in the first direction to a first position.

2. The safety device of claim 1 wherein the cord winder comprises a flange for engaging the first side and the second side when the cord winder rotates in the first direction.

3. The safety device of claim 1 wherein the pulley rotates freely relative to the cord winder.

4. The safety device of claim 1 wherein the pulley is mounted on a spindle such that the pulley rotates freely relative to the spindle.

5. The safety device of claim 4 wherein the cord winder is mounted on the spindle over the pulley.

6. The safety device of claim 2 wherein the cord winder comprises a second flange that is opposed to the first flange.

7. The safety device of claim 1 wherein the motor comprises a spring.

8. The safety device of claim 7 wherein the spring is deformed to store energy when the cord winder is rotated in a second direction.

9. The safety device of claim 7 wherein the spring is positioned inside of a hub of the cord winder.

10. The safety device of claim 1 wherein in the first position the end loop of the endless cord is looped around the pulley and a length of the first side and a length of the second side are wound around the cord winder.

11. The safety device of claim 10 wherein in the first position the safety device is retracted adjacent to a head rail of a window covering.

12. The safety device of claim 1 wherein the safety device assumes a second position where the cord is completely unwound from the cord winder and the end loop is wrapped around the pulley.

13. The safety device of claim 12 further comprising a restraining device for holding the cord winder against rotation in the first direction.

14. The safety device of claim 13 wherein the cord winder and pulley are located in a housing and the first side and the second side extend from the housing.

15. The safety device of claim 14 wherein the restraining device engages the housing and the cord winder to hold the cord winder in position relative to the housing.

16. The safety device of claim 14 wherein the restraining device comprises a mounting screw for attaching the safety device to a support structure.

17. A method of assembling a safety device for a window covering comprising an endless loop cord having an end loop and a first side and a second side, comprising:
reeving the end loop around a pulley;
rotating a cord winder in a first direction such that as the cord winder rotates in the first direction the first side and the second side of the endless loop cord are substantially wound on the cord winder and the end loop is wrapped around the pulley.

18. The method of claim 17 further attaching the first side and the second side to an operating system of a window covering.

19. The method of claim 17 wherein the step of rotating the cord winder comprises rotating the cord winder with a spring motor.

20. A safety device for a window covering comprising an endless loop cord having an end loop and a first side and a second side, comprising:
a pulley assembly including a rotatable pulley receiving the end loop of a cord;
a cord winder mounted to the pulley assembly for independent rotation relative to the pulley, the cord winder winding both sides of the cord when rotated in a first direction;
a releasable connection configured to allow the cord winder to be removed from the pulley assembly.
